(19) United States
(12) Patent Application Publication
(10) Pub. No.: US 2006/0065201 A1
(43) Pub. Date: Mar. 30, 2006

(54) Combination water reservoir and dog collar

(76) Inventors: Mary Ann Cogliano, Santa Rosa, CA (US); Noreen D. Miller, Highlands, NJ (US); Helen D. Kunik, Cape Coral, FL (US); Patricia Dempsey, Lehigh Acres, FL (US)

Correspondence Address: HOFFMAN, WASSON & GITLER, P.C.;Mitchell B. Wasson, Esq., Suite 522, 2461 S. Clark Street, Arlington, VA, 22202, US

(21) Appl. No.: 10/951,619

(22) Filed: Sep. 29, 2004

(51) Int. Cl. A01K 5/01

(52) U.S. Cl. 119/61.56

(57) ABSTRACT

A combination pet collar and water reservoir adapted to be worn around the neck of an animal, such as a dog, allowing the dog to be easily hydrated during a walk or hike. The water reservoir contains a dispensing device connected to a combination stopper and telescoping cup. Prior to hydration, the stopper is removed from a dispensing device and extends to form a cup. Water is squeezed from the interior of the water reservoir, allowing it to flow through the dispensing device, thereby filling the cup. In this manner, a dog will be allowed to hydrate itself without the necessity of removing the water reservoir from around the dog's neck or body.

### FIELD OF THE INVENTION

The field of invention relates generally to a water container for a pet, such as a dog, the water container worn around the neck of the pet.

### BACKGROUND OF THE INVENTION

It is generally believed that dogs were one of the first domesticated animals. It is likely that this domestication began around the time that man ceased to be a hunter-gatherer and settled into one location and began farming. In this endeavor, dogs were quite helpful on the farm in various capacities such as herding animals. Although this work could be arduous for the dog, thereby requiring that the dog be hydrated periodically during the day, since most farms are provided with either a natural or man-made source of water, the dog would have no problem in refreshing itself with a long deserved drink of water. Since the “working” dog spent the majority of its day involved in various farm activities, it was not essential that a specific time be set aside for exercising the dog.

As more and more people have moved from the farm into a suburban, or urban, setting, the dog's role in man's life has changed from that of the working dog to that of a pet or companion. In this new lifestyle, in which the dog spent a large portion of its life in a house or an apartment, the dog would hydrate itself by the utilization of a water bowl put out and replenished by its owner. Additionally, since these dogs were no longer getting the same type of exercise that it received on the farm, its owner generally took the dog for a walk during the course of the day. However, for the most part, these walks were short in nature and the need of hydrating the dog during this walk was generally not necessary.

Recently, more and more people have been walking or running greater and greater distances. If this long distance runner or walker owned a dog, in many instances, the dog would accompany its owner on these long walks or runs. Furthermore, the dog would endure long walks when its owner decided to hike or travel long distances. In these examples, it is important for the dog to be hydrated during the course of its walk or run.

Many walkers or runners would carry a bottle of water or fortified liquid during the course of the walk or run. That individual would periodically stop and hydrate himself or herself by drinking directly from the liquid container or through the utilization of a straw-like device. However, when these individuals are accompanied by a dog, it would be very difficult to hydrate the dog in the same manner without the necessity of carrying a water bowl along with the liquid container on the walk or run. As can be appreciated, the inclusion of both a liquid container and a water bowl during the course of a walk or run would be cumbersome, at best.

Even toting a water bottle, particularly on a long run, was found to be burdensome for various runners. Therefore, several patents have described systems in which a water container is attached to the body of the walker or runner. These patents include U.S. Pat. No. 4,090,650 to Gotta; U.S. Pat. No. 5,104,016 to Runkel; U.S. Pat. No. 6,581,811 to Schillaci; U.S. Pat. No. 6,598,770 to Bolts and U.S. Pat. No. 6,666,360 to Swank.

For example, the patent to Gotta shows a canteen 12 in the form of a belt adapted to be attached to the torso of a human. Retractable straws 5, 17 may be pulled out of the canteen and inserted into the mouth of the human, thereby allowing the human to drink from the canteen without the necessity of removing the canteen from the human's body. However, as can be appreciated, it would be very difficult for a dog to utilize this device, since, even if this device could be worn by the dog, it would be very difficult for the dog to utilize the straw to extract water from the canteen.

The patent to Bolts illustrates a beverage container belt attached to the torso of a human through the use of a Velcro-type attachment. Similar to the patent to Gotta, the belt would be provided with a flexible and extendable straw 60, having a first end 62 that receives liquid from the belt and a second end 64 for the ultimate delivery of the liquid to the mouth of a user 12. Similar to the patent to Gotta, it would be quite difficult for the dog to utilize the straw to hydrate itself.

The patent to Runkel discloses a pressurized beverage drinking system including a water holder 25 in which a bladder 13 having water therein is included. A drinking tube 15 is provided between a user's mouth and the bladder 13. As was true with respect to the Gotta and Bolts patents, it would be very difficult for a dog to hydrate itself utilizing a straw connected to a source of liquid.

The patent to Swank shows a personal hydration system for runners including a pack 20, in which a liquid-filled bladder 90 is held. A squeeze bottle 10 is connected to the bladder 90 through a tube 27. Therefore, in use, the runner would squeeze the bottle 10 to extract liquid from the bladder 90. Obviously, it would be very difficult for a dog to utilize this type of system to hydrate itself.

The patent to Schillaci illustrates a container 20 for flowable material adapted to be worn by an individual. In use, the container 20 is removed from the body and a compressive force is applied to the container to force the liquid through an opening into the user's mouth. Since this drinking container does not utilize a straw, it must be removed from the individual's body before it can be utilized.

Therefore, by their very construction, all of the previously described patents could not be very easily utilized by a dog or other pet to hydrate themselves.

Several patents have issued which address the problem of hydrating a dog. These patents include U.S. Pat. No. 6,101,974 issued to Frohlich; U.S. Pat. No. 6,516,748 issued to Jackson; and U.S. Pat. No. 6,571,745 issued to Kerrigan.

The patent to Jackson describes a combination pet collar and water bowl. As shown in the drawings, the collar 10 includes a waterproof band 12 constructed from an inner ply 14, a middle ply 16 and an outer ply 18. The band 12 contains at least one compartment 20 to be filled with drinking water and a storage compartment for a water bowl 50. In use, the collar must be removed from around the neck of the dog and the water bowl obtained from the interior of the band 12. Water is then forced from the collar into the bowl, allowing the dog to be hydrated. However, the configuration of this combination pet collar and water bowl requires that not only the collar containing the water be removed from the dog, the collar must be opened and the water bowl removed and water from the interior of the collar be forced into the bowl. This process can tend to be very time consuming, particularly when the dog is thirsty and would require hydration immediately.

The patent to Frohlich shows a combination pet water bottle and bowl thereby eliminating the necessity of the owner from carrying both a water bottle and bowl for an extended period of time when the owner walks the dog. However, while the patent to Frohlich does contain a shoulder strap 12 fastened to the bottle 100 allowing the shoulder strap to be worn by the pet owner, this particular configuration could tend to be very unwieldy, particularly if the pet owner wishes to run with the dog.

The patent to Kerrigan describes a harness adapted to be worn by a dog. The harness includes various devices for fastening one or more bottles of water to the harness, as well as a water bowl. Therefore, in practice, for the dog to be hydrated, a bottle of water must be removed from the harness along with the water bowl, which would then be filled by the owner, allowing the dog to drink the water. As can be appreciated, this process forces the dog to carry both a water bottle and a water bowl, requiring the pet owner to remove both the water bottle and the water bowl from the dog's harness and then fill the water bowl from the water bottle before the dog can drink.

### SUMMARY OF THE INVENTION

The deficiencies of the prior art are addressed by the present invention which describes a liquid receptacle or reservoir adapted to be worn around the neck of a pet, such as a dog. The reservoir would include a cup attached to a spigot or retractable straw which in turn is connected to the reservoir. The reservoir is flexible in nature and would allow water to be dispensed into the cup for hydrating the dog without the necessity of removing the water reservoir or cup from around the neck of the dog. The reservoir without any additional attachments would be capable of being worn by the dog. Alternatively, the reservoir could be removably attached to a dog collar having an identification tag used to identify the dog. The water reservoir would generally aid in the reduction and risk of dehydration from heat when water would not be readily available from other sources. Additionally, the present invention would eliminate the inconvenience of carrying bulky water bottles or storing water bowls. The reservoir can easily be detached from the dog collar, allowing for use as a traditional dog collar complete with an identification tag. Alternatively, the water reservoir can be attached to the dog through the use of a harness.

The foregoing and other obvious features advantages of the invention will become more apparent from the following detailed description, which proceeds with reference to the accompanying drawings.

### BRIEF DESCRIPTION OF THE DRAWINGS

FIG. 1 is a perspective view of the combination dog collar and water reservoir worn by a dog;

FIG. 2 is a perspective view of the combination dog collar and water reservoir in the closed position;

FIG. 3 is a perspective view of the combination pet dog collar and water reservoir in the open position;

FIG. 4 is a side view showing an expandable cup attached to the water reservoir; and

FIG. 5 is a cutaway view of the expandable cup.

### DETAILED DESCRIPTION OF THE INVENTION

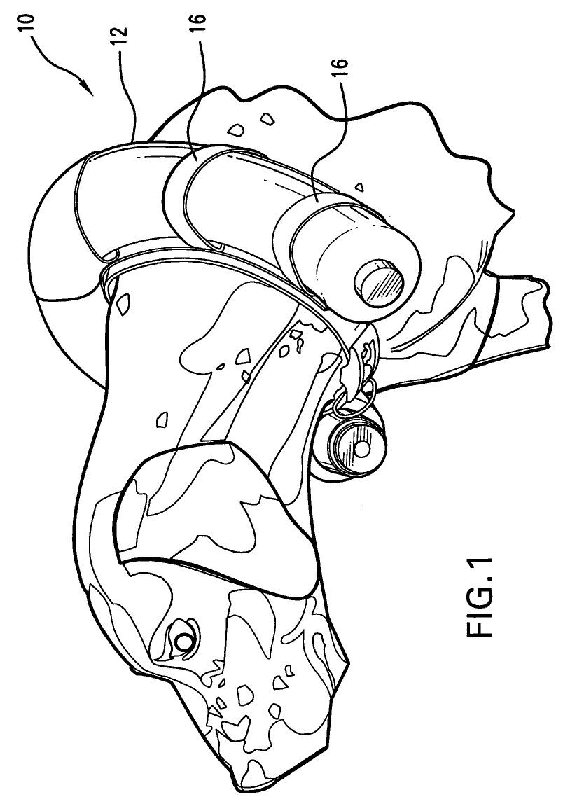

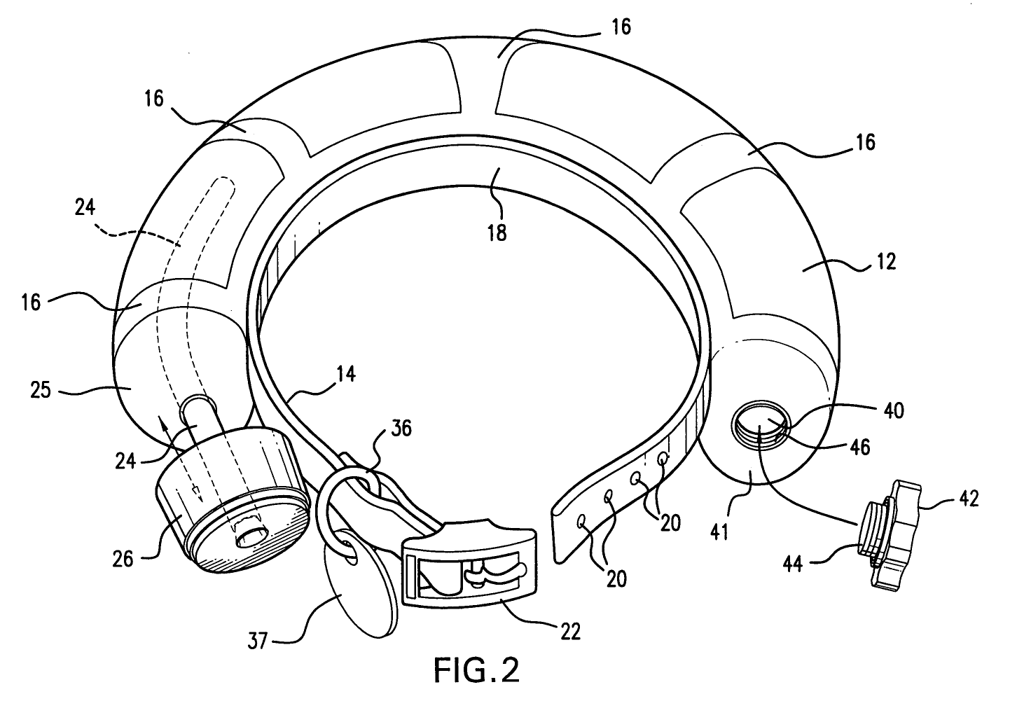

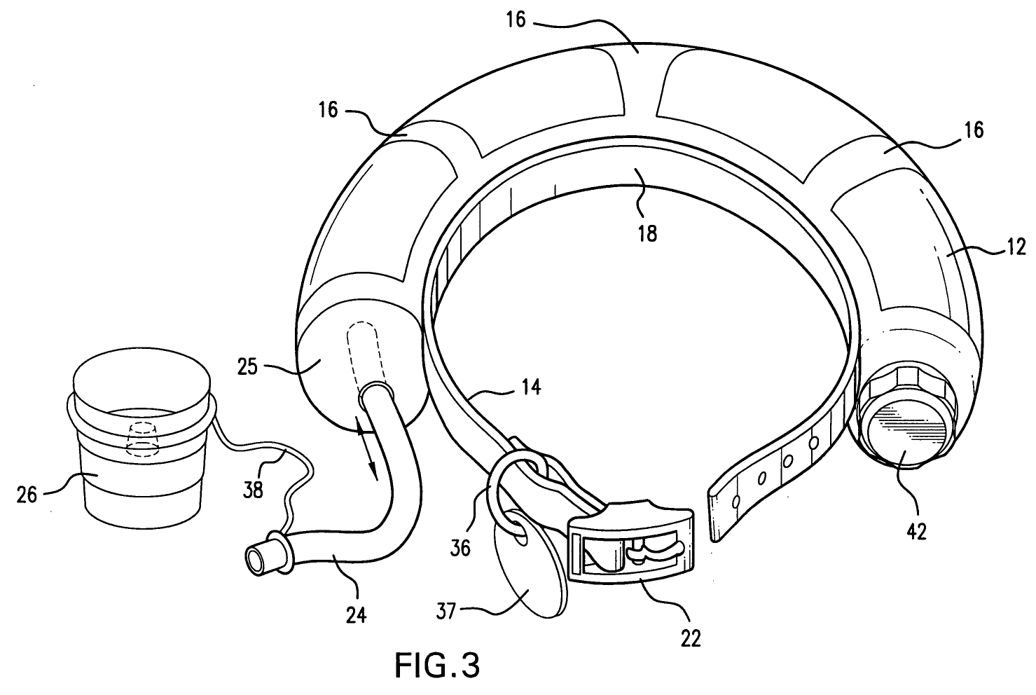

Referring to FIG. 1, the combination pet collar and water reservoir 10 includes a water reservoir 12 secured to the neck of the dog. The water reservoir 12 is generally tubular in shape and is formed from a plastic waterproof lining into which water or other types of fluids are introduced. The exterior of the water reservoir 12 can be formed from nylon or any other type of weather resistant and/or water resistant fabrics. A plurality of reflective strips 16 can be applied to the surface of the water reservoir 12. The purpose of these strips would be to provide additional safety for the dog or other pet as well as the pet's owner. The reflective strips 16 can be affixed to the exterior of the water reservoir 12 in virtually any manner such as reflective paint (see FIGS. 2 and 3) or be removable from the water reservoir 12 through the use of Velcro®-type strips (see FIG. 1). The water reservoir 12 is removably attached to a standard choke and harness type pet collar 14 to a standard choke and harness type pet collar 14 through various attachment devices, such as Velcro®-type strips provided both on the surface of the pet collar 14 as well as the surface of the water reservoir 12 (not shown). As can be appreciated, the water reservoir 12 and the pet collar 14 can come in various lengths and widths to accommodate differently-sized dogs.

FIG. 2 illustrates the combination dog collar and water reservoir with the reservoir 12 filled with a fluid either just prior to the combination pet collar water reservoir being secured to the animal or just subsequent to the combination pet collar and reservoir 10 being removed from around the animal's neck. As shown in FIG. 2, the reservoir 12 is secured to the pet collar 14 utilizing any state-of-the-art fastening devices in a manner allowing the reservoir 12 to be removed from the pet collar 14. The pet collar 14 would include a plastic or leather strap 18 having a buckle 22 at one end and a plurality of holes 20 at the opposite end, allowing the pet collar itself or in combination with the water reservoir 12 to be secured around the neck of the animal. An identification tag 36 is affixed in various manners to various portions of the strap 18 of the pet collar 14. A spigot-type dispensing member, such as a straw 24, would extend from one end 25 of the water reservoir 12. A cup 26 would be attached to one end of the dispensing member 24 through the use of a tether 38. The interior of the reservoir 12 is filled with a fluid, such as water, through one or more orifices 40 provided on the surface of the reservoir 12. As shown in FIG. 2, a single orifice is provided on end 41 of the water reservoir 12. A removable cap 42 having a screw-like projection 44 will cooperate with screw threads 46 to open and close the water reservoir 12. A tether could be provided between the interior of the end 41 at the cap 42 to prevent the loss of the cap 42 when it is removed from the reservoir 12. As shown in FIG. 2, the dispensing device 24 as well as the cup 26 are in the closed position. At this point, the combined water reservoir and dog collar can be secured to the dog's neck as shown in FIG. 1.

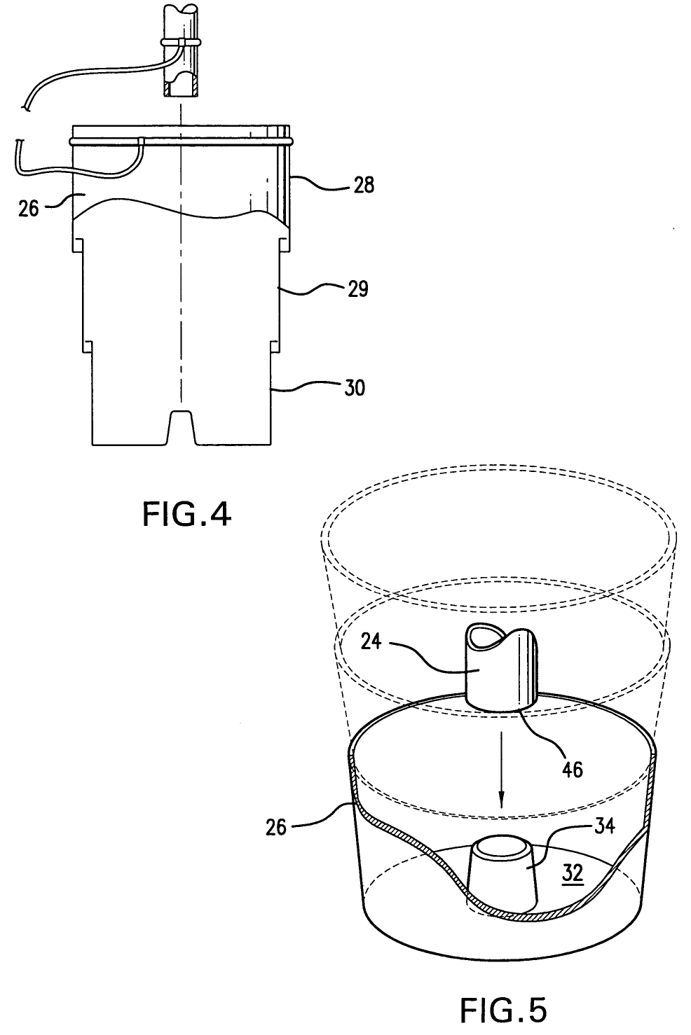

FIG. 3 shows the combination pet collar and water reservoir 10 in a position for dispensing water or other liquid from the interior of the reservoir 12. The dispensing device 24 could be an immovable straw which extends from the interior of the reservoir 12 in a manner allowing water to be dispensed into the cup 26. In this embodiment, a portion of the straw would initially extend into the interior of the reservoir 12. When in the dispensing mode, the cup 26, containing telescoping sections 28, 29 and 30 (see FIG. 4), would be removed from the dispensing device 24 in a manner allowing water or other fluid to be forced from the interior of the reservoir 12 through the dispensing device 24 and into the bottom 32 of the cup 26.

FIGS. 4 and 5 show various views of the dispensing device 24 and the cup 26. As shown therein, a small knob 34 is affixed to the bottom of the cup 32. When the combination pet collar and water reservoir is in the closed position as illustrated with respect to FIG. 2, the distal end 46 of the dispensing device 24 would be forced in the direction of the arrow included in FIG. 5 around the knob 34, thereby preventing water or other fluids from being dispensed from the device when the dispensing device is in the closed position.

Based upon the construction of the combination pet collar and reservoir 10, an animal can be easily and quickly hydrated during a long walk or hike. After fluid has been introduced into the reservoir 12 through the top 40, the top 40 is closed and the combination pet collar and water reservoir would be secured around the neck of the dog as shown in FIG. 1 with the combination pet collar/water reservoir in the closed position as illustrated in FIG. 2. Thereafter, at the appropriate time, the pet owner would pull the cup 26 away from the dispensing device 24 and extend the cup 26 to the position shown in FIG. 3. At this point, if the dispensing device 24 is an extendable straw, the straw would be extended and the owner would squeeze the reservoir 12, directing fluid therein to flow through the dispensing device 24 and into the cup 26. Obviously, if the dispensing device 24 is not extendable, once the cup is in the position shown in FIG. 4, the owner would squeeze the water reservoir, thereby directing fluid to flow from the reservoir through the dispensing device 24 and into the cup 26. At this point, the dog could easily lap the water provided within the cup 26. In this manner, the dog would become hydrated very quickly without the necessity of removing the combination pet collar and water reservoir from around the neck of the dog. In addition, since the combination pet collar/water reservoir is provided with its own drinking cup or bowl, it would not be necessary to have the owner carry a separate water bowl during the long walk or hike.

As previously indicated, the water reservoir 12 is removable from the pet collar 14. Therefore, when it is not necessary to hydrate the dog, the pet collar 14 would be worn by the dog in the usual manner, without the water reservoir 12 being connected to the pet collar 14.

The many features and advantages of the present invention are apparent from the written description. Furthermore, many modifications and changes will readily occur to those skilled in the art and is therefore not designed to limit the invention to the exact construction and operation of the invention as illustrated and described. Hence, all suitable modifications and equivalents may be considered to fall within the scope of the invention.

What is claimed is:

1. A fluid reservoir for hydrating an animal with a fluid, comprising:
a tubular container provided with an inner chamber in which the fluid is stored, said tubular container provided with a first orifice for filling said inner chamber with the fluid and a second orifice for dispensing the fluid from said inner chamber;
an attachment device for attaching said tubular container to the body of the animal;
a dispensing device provided in said second orifice for assisting in the dispensing of the fluid from said inner chamber; and
a receptacle connected to said dispensing device for preventing fluid from being dispensed from said inner chamber when said receptacle is a first closed position and for receiving the fluid after the fluid has been dispensed from said inner chamber, when said receptacle is a second opened position situated at a distance removed from said second orifice, wherein water is dispensed from said inner chamber into said receptacle, allowing the animal to drink the fluid from said receptacle without removing said tubular container from the animal.

2. The fluid reservoir in accordance with claim 1, wherein said attachment device is a pet collar.

3. The fluid reservoir in accordance with claim 2, further provided with an identification tag attached to said pet collar.

4. The fluid reservoir in accordance with claim 1, wherein said dispensing device is a straw.

5. The fluid reservoir in accordance with claim 4, wherein said straw extends from a first position in which said straw is predominately within said inner chamber to a second position where said straw is predominately outside of said inner chamber.

6. The fluid reservoir in accordance with claim 1, wherein said receptacle is a telescoping cup.

7. The fluid reservoir in accordance with claim 4, wherein said receptacle is a telescoping cup.

8. The fluid reservoir in accordance with claim 1, further including a plurality of reflective strips adhered to the outside surface of said tubular container.

9. The fluid reservoir in accordance with claim 1, wherein said tubular container is constructed from a resilient material.

10. The fluid reservoir in accordance with claim 1, wherein said receptacle is provided with a knob cooperating with the distal end of said dispensing device to prevent a fluid from being dispensed from said inner chamber when said receptacle is in its first position.

11. The fluid reservoir in accordance with claim 6, wherein said receptacle is provided with a knob cooperating with the distal end of said dispensing device to prevent a fluid from being dispensed from said inner chamber when said receptacle is in its first position.

12. The fluid reservoir in accordance with claim 1, wherein said receptacle is connected to said dispensing device by a tether.

13. The fluid reservoir in accordance with claim 2, wherein said pet collar is a harness and choke type.

14. A method of hydrating an animal, comprising the steps of:
filling a flexible container provided with a dispensing device and a receptacle connected to said dispensing device, with a fluid;
attaching said container to the animal;
disconnecting said receptacle from said dispensing device;
squeezing the exterior of said flexible container, thereby emptying a portion of the fluid from said container into said receptacle; and
presenting said receptacle with a fluid therein to the animal, thereby allowing the animal to drink the fluid, wherein said disconnecting step, said squeezing step and said presenting step performed with said container remaining attached to the animal.

15. The method of hydrating an animal in accordance with claim 14, further including the step of moving said dispensing device from a first position predominately within said flexible container to a second position predominately outside of said flexible container prior to said squeezing step.

16. The method in accordance with claim 14, wherein said receptacle is a telescoping cup and further including the step of opening said cup from a closed position to an opened telescoped position prior to said squeezing step.
